(19) United States
(12) Patent Application Publication
(10) Pub. No.: US 2005/0256777 A1
(43) Pub. Date: Nov. 17, 2005

(54) Intellectual property right selling/buying system and method, program thereof and recording medium

(76) Inventors: Yasuo Kotera, Fukushima-ken (JP); Takao Tazawa, Kanagawa-ken (JP)

Correspondence Address: BRINKS HOFER GILSON & LIONE, P.O. BOX 10395, CHICAGO, IL, 60610, US

(21) Appl. No.: 10/514,605

(22) PCT Filed: May 1, 2003
(86) PCT No.: PCT/JP03/05573

§ 371 Date: Nov. 16, 2004

(30) Foreign Application Priority Data
May 21, 2002 (JP) 2002-146607

(51) Int. Cl. G06F 17/60

(52) U.S. Cl. 705/26

(57) ABSTRACT

An intellectual property right selling/buying system and method enables transfer of an intellectual property right selling/buying right to a broker by employing the call option method and acquiring a call option fee. An application for selling a right to be sold is received from an applicant terminal and a value evaluation price of the right is determined by referencing a right evaluation database. According to a selling period applied and the value evaluation price, a call option fee is calculated, and the sale price of the right is determined based on the value evaluation price and the call option fee. In the event that a trading is successful, a purchase price is transferred from the buyer to the broker and refunds determined based on the value evaluation price and the call option fee is transferred from the broker to the applicant.

### TECHNICAL FIELD

The present invention relates to an intellectual property right selling/buying system for performing selling/buying an intellectual property right in a trading market, specifically relates to an intellectual property right selling/buying system, an intellectual property right selling/buying method, a program thereof, and a recording medium, whereby an intellectual property right such as a patent right, utility model right, right to receive these, and a license by agreement (exclusive license, or non-exclusive license) is sold or bought in a trading market, and also these rights are transferred to a broker by acquiring a call option fee.

### BACKGROUND ART

Nowadays, the environment surrounding intellectual property rights is such as described below.

Let us say that a certain venture business enterprise or the like has excellent technical capabilities, but in some cases, cannot expand due to lack of funds. Intellectual property rights (especially patent rights) possessed by the enterprise could serve as an opportunity for business expansion. A venue for such opportunities is desired strongly.

Also, of intellectual property rights possessed by enterprises or universities, in particular, with regard to patent rights, numerous so-called “sleeping” patent rights that have not been used yet exist, it is strongly desired to devise liquidity and effective use of these patent rights, and contribute to economic activation.

In order to respond to these social needs, various countermeasures for promoting liquidity of patent rights in particular have been devised, such as establishment of institutions for enabling the sleeping patent rights possessed by enterprises to be sold or bought (for example, TLO (Technology Licensing Organization)), or enabling patent rights and licenses to be sold or bought by subjecting these to securitization (creation of a property liquidity law), or the like.

On account of this, there is demand for establishment of patent circulation and technology transfer markets wherein sellers and buyers handling a wider range of patent rights can participate, and development of an intellectual property right selling/buying system for managing the market effectively, as soon as possible.

It is effective to perform selling/buying an intellectual property right in a market through a professional broker (or intermediary agency) having broad experience on selling/buying thereof. With regard to an intellectual property right providing enterprise for selling an intellectual property right, it is desirable for a broker to purchase the intellectual property right to be sold, from the aspect of fund management.

However, in the event that a broker purchases and sells an intellectual property right to be sold, since the burden of purchase funds on the broker becomes heavy, and risk in the case wherein the right is unsold is high, the broker attempts to purchase intellectual property rights as cheap as possible. Consequently, enterprises providing intellectual property rights cannot make a profit on selling of intellectual property rights in light of development costs, acquisition of rights, and cost of maintenance, resulting in becoming negative regarding selling of intellectual property rights in some cases.

### DISCLOSURE OF INVENTION

The present invention has been made in light of the above-described current situation, and accordingly, it is an object of the present invention to provide an intellectual property right selling/buying system and method, a program thereof, and a recording medium, whereby in the event of selling an intellectual property right via a broker, a call option (acquisition of trading rights) system is employed, and a call option fee is collected, and transfers the trading right of the intellectual property right to the broker.

Accordingly, the present invention provides an intellectual property right selling/buying system comprising:
a selling application reception unit for receiving information regarding the selling application of a right to be sold, the content of a right, and a selling period, from an applicant terminal applying for sale of an intellectual property right;
a database for retaining evaluation data to be used for evaluation of the right to be sold;
a price evaluation calculation unit for referencing the database, and determining a value evaluation price of the right to be sold;
a call option fee calculation unit for calculating a call option fee based on the selling period and the value evaluation price in accordance with a certain standard;
a sale price determining unit for determining a sale price of the right to be sold based on the value evaluation price and the call option fee;
a reception unit for receiving information to the effect that a buyer terminal desiring to apply for purchase of the right to be sold applies for purchase;
a purchase payment transfer instruction unit for sending instruction information for instructing the buyer to transfer purchase payment to a broker to the buyer terminal in the event that the buyer terminal applied for purchase, and trading is successful; and
a refund transfer instruction unit for sending instruction information for instructing the broker to transfer refunds determined based on the value evaluation price and the call option fee to an applicant to the broker terminal in the event that the trading is successful.

Thus, the broker can accept purchase of an intellectual property right at a relatively cheap price, and also avoid risk in the case wherein the right is unsold. Also, a value evaluation price, a call option fee, and a sale price can be automatically determined.

An arrangement may be made wherein the intellectual property right selling/buying system further comprises an option rate database correlating the selling period, the value evaluation price, with calculation rate data of a call option fee, and recording these,
the call option fee calculation unit references the option rate database, and calculates the call option fee.

Thus, a call option fee can be easily calculated.

Also, an arrangement may be made wherein the intellectual property right selling/buying system further comprises:
a desired sale price reception unit, when the selling application reception unit receives the selling application of an intellectual property right from an applicant, for receiving information of desired sale price of the applicant;
a sale price comparison unit for comparing a calculated sale price calculated from the value evaluation price and the call option fee with the desired sale price; and
a listing unit for listing the content of a right to be sold, and the calculated sale price in the case wherein the desired sale price is equal to or less than the calculated sale price.

Thus, intellectual property rights to be listed can be narrowed down to intellectual property rights having high economic efficiency, which can be selectively listed.

An arrangement may be made wherein the intellectual property right selling/buying system further comprises a call option fee increase unit for increasing the call option fee for each certain period in the event that the remaining period of the selling period reaches a predetermined limit period or less.

Thus, penalizing brokers promotes selling of intellectual property rights.

An arrangement may be made wherein the call option fee increase unit stops increase of the call option fee in the event that a buying price serving as a current sale price and the call option fee satisfy the following relation:
buying price−call option fee<value evaluation price.

Thus, the broker can be prevented from taking a loss.

An arrangement may be made wherein the intellectual property right selling/buying system further comprises a call option fee increase notification unit for sending the call option fee increase information to the terminal of the broker in the event that said call option fee is increased.

Thus, since the broker can recognize increase of the call option fee, selling of intellectual property rights can be promoted.

An arrangement may be made wherein the intellectual property right selling/buying system further comprises a call option fee refund instruction unit for sending information to the terminal of the applicant for instructing the applicant to refund to the broker the call option fee paid to the applicant in the event that the right to be sold is sold.

Thus, the broker can yield further profits in the event that an intellectual property right is sold, and accordingly, the broker can promote his/her business activities.

The present invention also provides an intellectual property right selling/buying method comprising:
a selling application reception step for receiving information regarding the selling application of a right to be sold, the content of a right, and a selling period, from an applicant terminal applying for sale of intellectual property;
a price evaluation calculation step for referencing a property right database for retaining evaluation data to be used for evaluation of the right to be sold, and determining a value evaluation price of the right to be sold;
a call option fee calculation step for calculating a call option fee based on the selling period and the value evaluation price in accordance with a certain standard;
a sale price determining step for determining a sale price of the right to be sold based on the value evaluation price and the call option fee;
a reception step for receiving information to the effect that a buyer terminal desiring to apply for purchase of the right to be sold applies for purchase;
a purchase payment transfer instruction step for sending instruction information for instructing the buyer to transfer purchase payment to a broker to the buyer terminal in the event that the buyer terminal applied for purchase, and trading is successful; and
a refund transfer instruction step for sending instruction information for instructing the broker to transfer refunds determined based on the value evaluation price and the call option fee to an applicant to the broker terminal in the event that the trading is successful.

Thus, the broker can accept selling of intellectual property rights at a relatively cheap price, and also can avoid risk in the case wherein the rights are unsold. Also, a value evaluation price and a call option fee can be automatically determined.

The present invention also provides a program for controlling a computer to execute intellectual property right selling/buying processing corresponding to the aforementioned intellectual property right selling/buying method, and a computer-readable recording medium recording the program.

### BRIEF DESCRIPTION OF THE DRAWINGS

FIG. 1 is a diagram for illustrating the concept of an intellectual property trading market to which an embodiment of the present invention is applied.

FIG. 2 is a diagram for describing the overview of the flow of funds in an intellectual property right selling/buying system of the present embodiment.

FIG. 3 is a diagram illustrating the specific system configuration example of the intellectual property right trading market in the intellectual property right selling/buying system of the present embodiment.

FIG. 4 is a diagram illustrating the data configuration example of an option rate table.

FIG. 5 is a diagram for describing a method for calculating floating sale prices of intellectual property rights such as patent rights.

FIG. 6 is a diagram illustrating the example of an option rate-of-increase table.

FIG. 7 is a flowchart for describing the detailed flow of selling/buying procedures of intellectual property rights.

FIG. 8 is a block diagram illustrating the configuration example of Web site server.

### BEST MODE FOR CARRYING OUT THE INVENTION

An embodiment of the present invention will now be described in detail with reference to the drawings.

<Concept of Intellectual Property Trading Market>

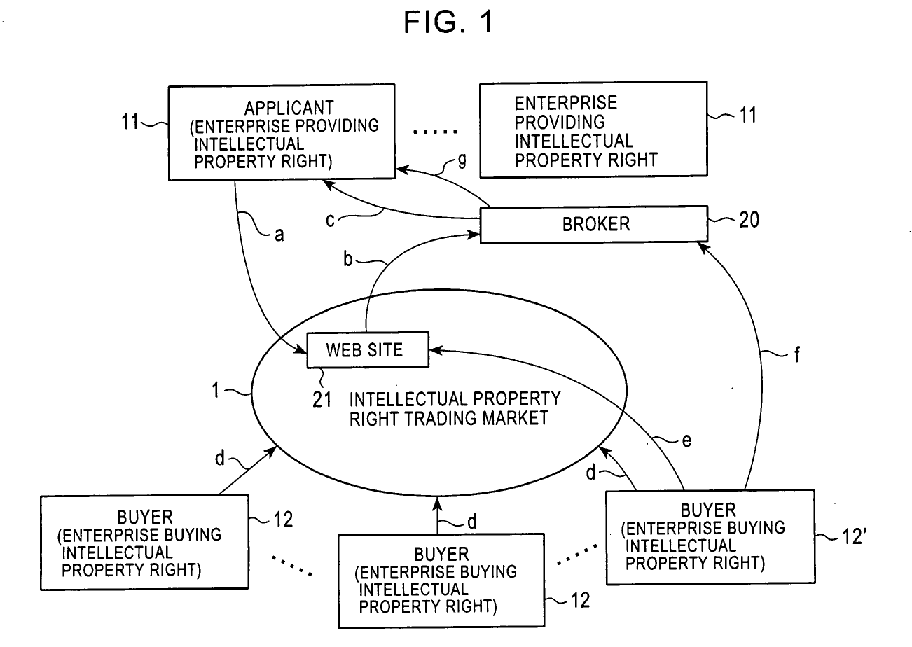

FIG. 1 is a diagram for describing the concept of an intellectual property right trading market to which an intellectual property right selling/buying system according to an embodiment of the present invention is applied. Description will be made below regarding the intellectual property right trading market to which the present embodiment is applied, e.g., a Web site is applied with reference to FIG. 1.

An applicant (enterprise providing intellectual property right) 11 desiring to sell an intellectual property right such as a patent right applies to an Web site 21 for managing an intellectual property right trading market 1 for selling an intellectual property right to be sold (arrow-headed line a).

Next, a value evaluation price and a call option fee regarding the intellectual property right applied for selling are determined at the Web site 21, and these are presented to the applicant 11. In the event that the applicant 11 agrees with the presented value evaluation price and call option fee, to that the right is sellable is notified to the Web site 21 (arrow-headed line b).

Here, the term call option means a right to purchase intellectual property rights to be sold, and a right to sell intellectual property rights to be sold to a buyer at a free price during a certain period.

Next, in the event that the broker 20 purchases the selling/buying right of the intellectual property right to be sold, the broker 20 pays the call option fee to the applicant 11 (arrow-headed line c), and acquires the selling/buying right to the intellectual property right. At the Web site 21, the content of the intellectual property right to be sold, and the sale price thereof are listed on the intellectual property right trading market 1 (listed on the Web site 21).

On the other hand, a buyer (enterprise buying intellectual property right) 12 of an intellectual property right reads the intellectual property right listed on the intellectual property right trading market 1 (arrow-headed line d), and makes the Web site 21 an application for purchase (bid) (arrow-headed line e). Note that in the event that the multiple buyers 12 make an application for purchase, a buyer 12′ presenting the highest purchase price makes a successful bid.

Next, at the Web site 21, the application for purchase (bid) from the buyer 12′ is notified to the broker 20, upon the selling/buying of the intellectual property right being concluded, the buyer 12′ remits a purchase price to the broker 20 (arrow-headed line f).

In response to this, upon the broker 20 receiving the purchase price from the buyer 12′, the broker 20 pays a refund (value evaluation price−call option fee) to the applicant 11 (arrow-headed line g).

Note that in the event that an intellectual property right to be sold has been listed on the intellectual property right trading market 1 for a predetermined period (for example, one year), but a buyer 12 has not shown up, listing the intellectual property right is cancelled. This case results in a loss of the call option fee to the broker 20.

The intellectual property right selling/buying system of the present embodiment is applied under the assumption of the above-described intellectual property right trading market 1.

<Overview of Flow of Funds>

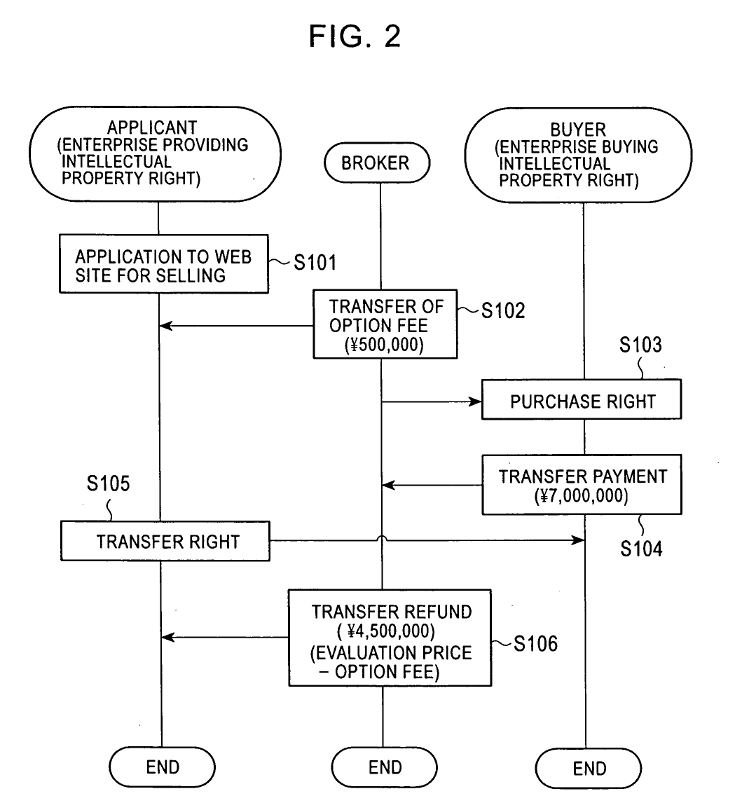

Next, description will be made regarding the overview of the flow of funds in the intellectual property right selling/buying system of the present invention with reference to FIG. 2. Here, description will be made on the assumption that the evaluation price of the intellectual property right to be sold is ¥5,000,000.

First, the applicant (enterprise providing intellectual property right) 11 desiring to sell an intellectual property right applies to the Web site 21 (intellectual property right trading market) for selling of an intellectual property right (Step S101). At this time, a desired selling period is also applied for.

Next, the broker 20 desiring to purchase the selling/buying of an intellectual property right to be sold pays, for example, ¥500,000 which is equivalent to 10% of the value evaluation price of the intellectual property right to the applicant 11 as a call option fee (Step S102).

Next, in the event that the intellectual property right is sold at ¥7,000,000, the buyer (enterprise buying intellectual property right) 12 desiring to purchase the intellectual property right remits the purchase price, ¥7,000,000 to the broker 20 (Step S103 and S104).

Next, upon the transfer registration of the intellectual property right from the applicant 11 to the buyer 12 being completed (Step S105), the broker 20 pays ¥4,500,000 obtained by subtracting the call option fee from the value evaluation price, i.e., ¥5,000,000−¥500,000 to the applicant 11 from ¥7,000,000 received (Step S106).

Note that an arrangement may be made wherein the applicant 11 and the broker 20 determine a negotiation price (for example, ¥6,000,000) with reference to the value evaluation price (¥5,000,000), and a call option fee and refunds are calculated depending on this negotiation price.

For example, in the case wherein the value evaluation price is ¥5,000,000, negotiation price is ¥6,000,000, call option fee is ¥540,000 as 9% of the negotiation price, and the sale price is ¥7,000,000, since the broker 20 pays payment of (¥6,000,000−¥540,000)=¥5,460,000 corresponding to “negotiation price−call option fee”, the broker 20 makes a profit of ¥1,000,000, obtained by ¥7,000,000−(¥540,000+¥5,460,000).

<Specific System Configuration of Intellectual Property Right Trading Market>

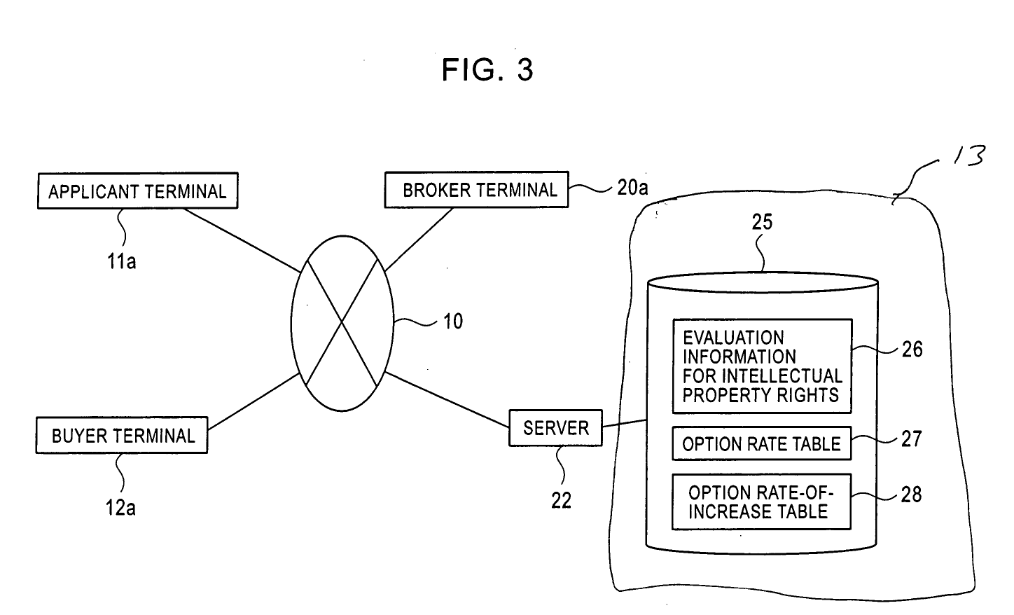

Next, description will be made regarding the specific system configuration of the intellectual property right trading market in the intellectual property right selling/buying system of the present embodiment with reference to FIG. 3.

In FIG. 3, 11a denotes an applicant terminal possessed by the applicant 11 applying for selling of an intellectual property right such as a patent right, 12a denotes a buyer terminal possessed by the buyer 12 desiring to purchase an intellectual property right such as a patent right, 13 denotes a server installed in an evaluation organization for performing price evaluation of intellectual property rights, and 20a denotes a broker terminal possessed by the broker 20 selling the selling/buying right of an intellectual property right. 22 denotes a server for managing an Web site for establishing the intellectual property right trading market 1 on the Internet 10, and selling/buying intellectual property rights in an auction form. 25 denotes a database within the server 22, and is made up of evaluation information for intellectual property rights 26, an option rate table 27, and an option rate-of-increase table 28.

With the intellectual property right selling/buying system of the present embodiment, the server 22 in the Web site 21 serves as the core thereof, and the intellectual property right trading market is established on the Internet 10, whereby selling/buying intellectual property rights such as patent rights to be sold can be performed.

<Specific Management Example of Call Option>

Next, description will be made regarding the specific management example of the call option according to the present invention.

1. Method for Determining Call Option Fee

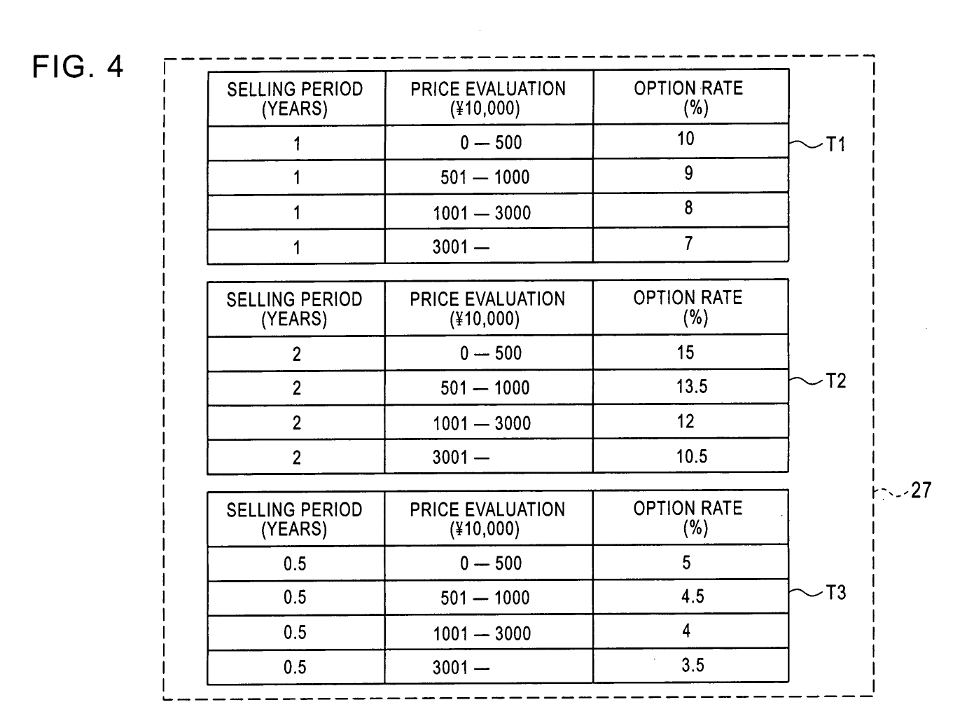

A call option fee is determined using an option rate defined in the database beforehand. FIG. 4 is a diagram illustrating the table configuration of the option rate table 27 retained in the database 25.

With the call option rate table 27 shown in FIG. 4, the option ratio (%) varies depending on the selling period (listing period (year) on the intellectual property trading market 1), the value evaluation price (¥10,000), and the call option fee can be calculated using the following expression.
call option fee=value evaluation price (¥10,000)×option rate (%)/100

Here, description will be made on the assumption that the option rate table 27 comprises a table T1 in the case wherein the selling period is one year, a table T2 in the case wherein the selling period is two years, and a table T3 in the case wherein the selling period is a half year.

With respective tables T1, T2, and T3, option rates are defined for each price range of the respective value evaluation prices. For example, in the event that the selling period is one year, the option rate of a value evaluation price is defined such that value evaluation prices ¥0 through ¥5,000,000 is 10%, hereinafter in the same way, ¥5,010,000 through ¥10,000,000 is 9%, ¥10,010,000 through ¥30,000,000 is 8%, and ¥30,010,000 or more is 7%. The call option fee to be paid by the broker 20 to the applicant 11 is calculated based on the option rates defined in this table.

Note that in the event that a negotiation price is set as described above, the corresponding value evaluation price on the call option rate table 27 should be substituted with a negotiation price to determine an option rate.

Also, an arrangement may be made wherein a call option fee may be calculated uniformly using the following expression without using the table shown in FIG. 4.
call option fee=value evaluation price (¥10,000)×10%×selling period (year)/100
2. Method for Setting Initial Prices

Regarding how to set a publicly-offered sale price (initial price) in the case of listing the price on the intellectual property right trading market 1, in order that the broker 20 can yield at least the call option fee worth of profits, an initial price is calculated in accordance with the following expression.
initial price=value evaluation price+value evaluation price×call option rate/100

Note that this method prevents the broker 20 from jacking up an initial price based on his/her determination, whereby an appropriate initial price can be set. In this case, a sale price gets closer to the value evaluation price of an intellectual property right, and accordingly, a sale price corresponding to the worth of the intellectual property right can be set.

3. Case of Reflecting Fluctuation in Price of Intellectual Property Rights on Sale Prices

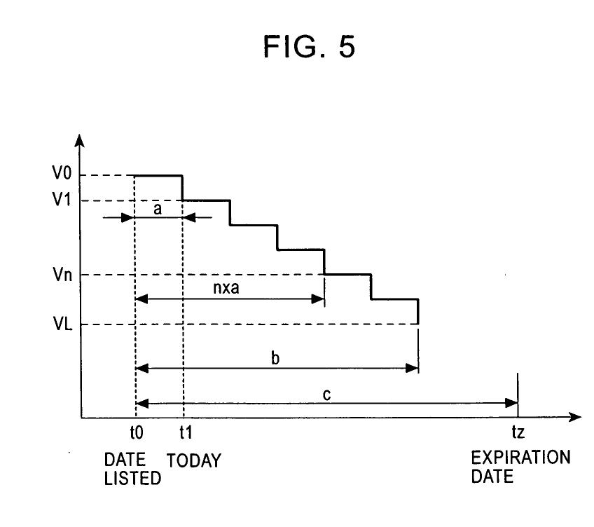

Also, as illustrated in FIG. 5, in the event that intellectual property rights listed on the intellectual property right trading market 1 are patent rights, or utility model rights, the worth thereof decreases depending on the right remaining period of the right and technical lifetime. In the event of reflecting this on sale prices, for example, sale prices are calculated such as shown in the following.

A first calculation of a floating sale price is performed at the time of a current date t1 when “a certain period a” has been elapsed since a date t0 when a patent right to be sold has been listed on the trading market (listed on the Web site 21), hereinafter the calculation of a floating sale price is performed using the following expression each time the “period a” is elapsed.
changed sale price Vn(sale price at the n'th calculation)=sale price prior to change V0×(1−n×a/c)

Here, n represents the number of times a floating sale price has been calculated.

A “basic days-to-expiration c” within the above expression denotes the basic days-to-expiration of a patent right to be sold at the time of calculating a floating sale price, and is obtained by comparing the expiration date of a patent right remaining period since a listing date with the final date of a technical lifetime, and employing a period up to whichever date is closer.

In an example illustrated in FIG. 5, while the sale price is gradually reduced step by step each time a calculation is performed, upon the sale price reaching a minimal limit price VL shown in the following expression or less, subtraction of the floating sale price is suspended (note reference character b in FIG. 5).
minimal limit price VL=initial sale price−call option fee=value evaluation price
4. Regarding Increase of Call Option Fee

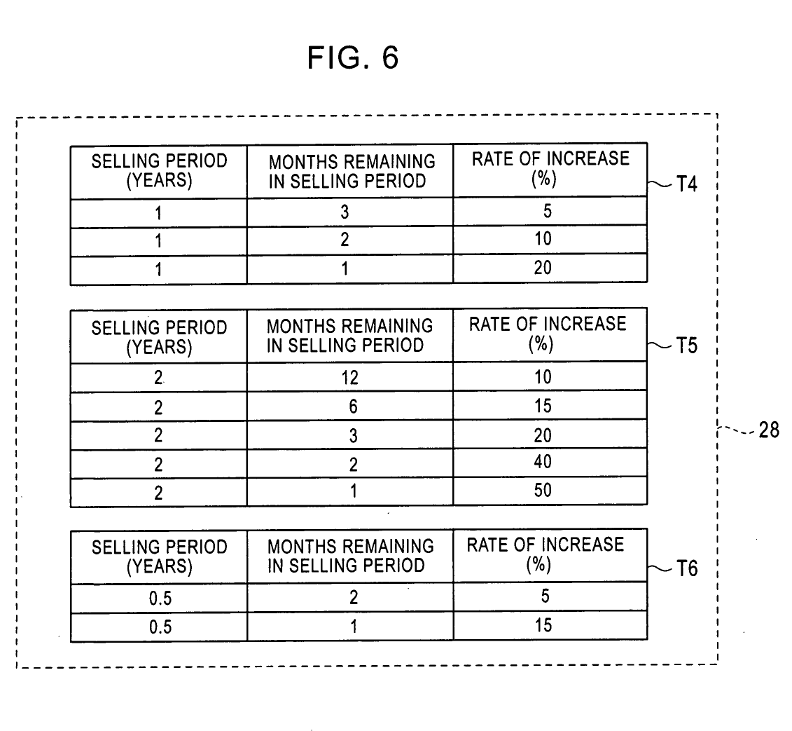

Also, FIG. 6 is a diagram illustrating an example of an option rate-of-increase table 28. This table is a table to be referred to in the event that the remaining period (remaining months) of a selling period has ended, and in the event that the call option fee is increased depending on the selling period and the remaining months of the selling period. Here, description will be made on the assumption that the option rate-of-increase table 28 comprises a table T4 in the case wherein a selling period is one year, a table T5 in the case wherein a selling period is two years, and a table T6 in the case wherein a selling period is a half year.

With the respective tables T4, T5, and T6, an increase rate is defined for each of the remaining moths of the corresponding selling period. For example, in the event that a selling period is one year, the increase rate in the case wherein the remaining months of the selling period is 3 is defined as 5%, hereinafter in the same way, the increase rate in the case wherein the remaining months of the selling period is 2 is defined as 10%, and the increase rate in the case wherein the remaining months of the selling period is 1 is defined as 20%.

The increase of a call option fee is a method used for prompting the broker 20 to sell an intellectual property right. In other words, with this trading arrangement, since a right to be sold is one, following waiting for a certain period, a deal is established for the highest asking price of multiple asking prices (purchase prices). However, with this method, the broker 20 is prompted to sell the right quickly, and the selling period is shortened, resulting in selling the right at a reasonable price.

Also, an arrangement may be made wherein keeping the relation of “current sale price−increased call option fee<value evaluation price” prevents a call option fee from increase event if the period expires. Thus, brokers can be prevented from taking a loss.

<Operation of Selling/Buying Procedures of Intellectual Property Right>

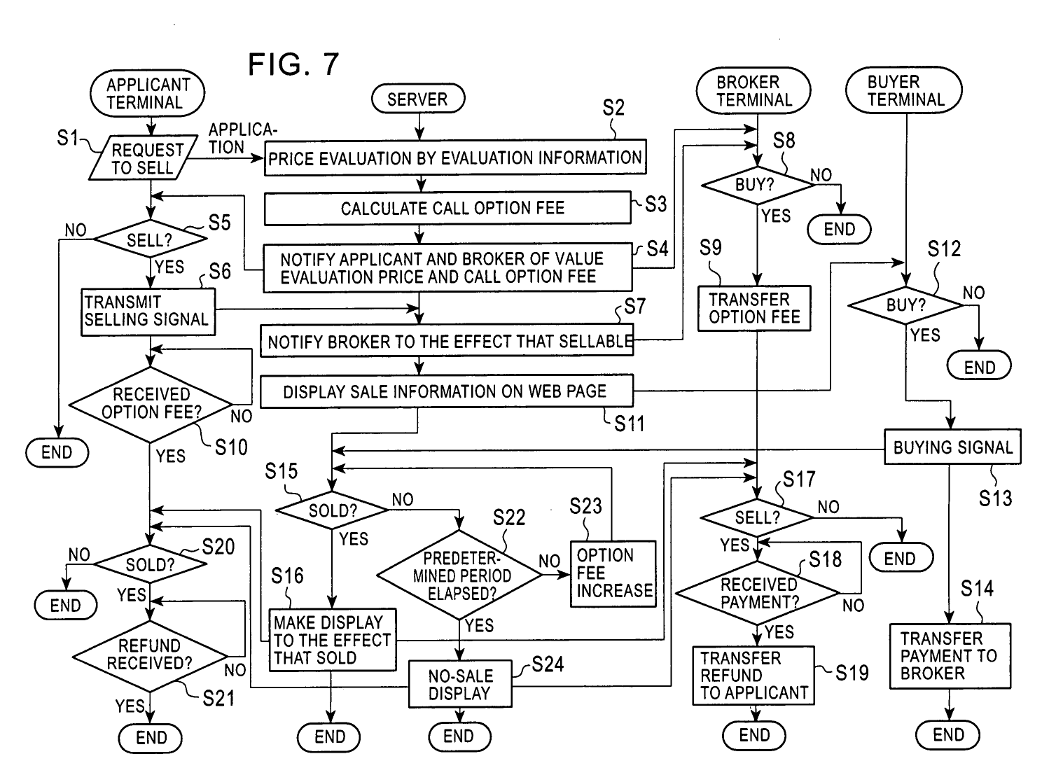

Next, description will be made regarding the detailed flow of selling/buying procedures of an intellectual property right in the intellectual property right trading market 1 illustrated in FIG. 3 with reference to FIG. 7.

First, the applicant 11 sends information of “application for selling (request to selling application)” of an intellectual property right such as his/her own patent right from the applicant terminal 11a to the server 22 in the Web site 21 (Step S1). This information includes the content of a right to be sold and a selling period.

Next, the server 22 in the Web site 21 accepts “application for selling”, makes a reference of the evaluation information for intellectual property rights 26 within the database 25, and determines the state of the right and value evaluation price of the intellectual property right to be sold (Step S2). Note that in the event that the information regarding the intellectual property right to be sold is not included in the database 25, necessary information is acquired from an external intellectual property right information providing organization (“Japan Patent Information Organization” and the like, in the case of patent rights), registered in the database 25, and used.

Next, following determining the value evaluation price, the server 22 makes reference to the option rate table 27 within the database 25, and calculates a call option fee (Step S3).

Subsequently, the server 22 displays the value evaluation price and call option fee on a Web page for applicants and brokers provided within the Web site 21. Also, the server 22 sends the value evaluation price and call option fee to the applicant terminal 11a of the applicant 11 and the broker terminal 20a of the broker 20 by e-mail (Step S4).

In response to this, the applicant terminal 11a of the applicant 11 receives the information of the value evaluation price and call option fee from the server 22 in the Web site 21, and determines whether or not the intellectual property right to be sold is sold at the value evaluation price and call option fee (Step S5). In the event of selling the right, the applicant terminal 11a of the applicant 11 sends a “selling signal” to the effect that selling is approved to the server 22 in the Web site 21 (Step S6).

Next, in the event that the server 22 in the Web site 21 receives the “selling signal” from the applicant terminal 11a of the applicant 11, makes a display “to the effect that the right is sellable” on the Web page for applicants and brokers. Alternatively, “to effect that the right is sellable” is notified to the broker terminal 20a of the broker 20 by e-mail (Step S7).

Next, the broker 20 sends the call option fee to the applicant in the event of purchasing the selling/buying right of the intellectual property right to be sold (Steps S8 and S9). Also, the broker terminal 20a of the broker 20 sends the information to the effect that the applicant 11 paid the call option fee to the server 22 in the Web site 21. Also, at the applicant terminal 11a of the applicant 11, determination is made whether or not the call option fee has been received (Step S10).

Next, the server 22 in the Web site 21 displays the content of the intellectual property right to be sold (Patent No. or sale price) on a Web page for presenting purchase prices (Step S11), and accepts the purchase price presentation of the buyer 12.

In response to this, in the event that the buyer 12 intends to purchase the intellectual property right to be sold, the buyer terminal 12a of the buyer 12 sends a “buying signal” to the server 22 in the Web site 21 (Steps S12 and S13). Also, in the event that trading is successful, the buyer 12 transfers “payment” to the broker 20 (Step S14).

Also, in the event that the server 22 in the Web site 21 receives the “buying signal” from the buyer terminal 12a of the buyer 12, the server 22 makes a display “to the effect that the right is sold” on the Web page for applicants and brokers, and notifies this to both the applicant and the broker (Steps S15 and S16).

Next, the broker 20 who has received the notification “to the effect that the right has been sold” from the server 22 in the Web site 21 determines whether or not to sell the right (Step S17), in the event of selling the right, receives the payment from the buyer 12 (Step S18). Also, in the event of receiving the payment from the buyer 12, the broker 20 transfers refunds (value evaluation price−call option fee) to the applicant 11 (Step S19). The applicant 11 receives the refunds (Steps S20 and S21).

On the other hand, in the event that the intellectual property right to be sold remains unsold, and the remaining period of the selling period reaches a certain number of months or less, the server 22 penalizes the broker 20 by increasing the call option fee for each certain period (Steps S22 and S23).

Or, in the event that the intellectual property right to be sold is remained unsold, and the selling period is elapsed, the server 22 makes a display “to the effect that the right is not sold” on the Web page for applicants and brokers (Steps S22 and S24).

<Configuration of Server in Web Site>

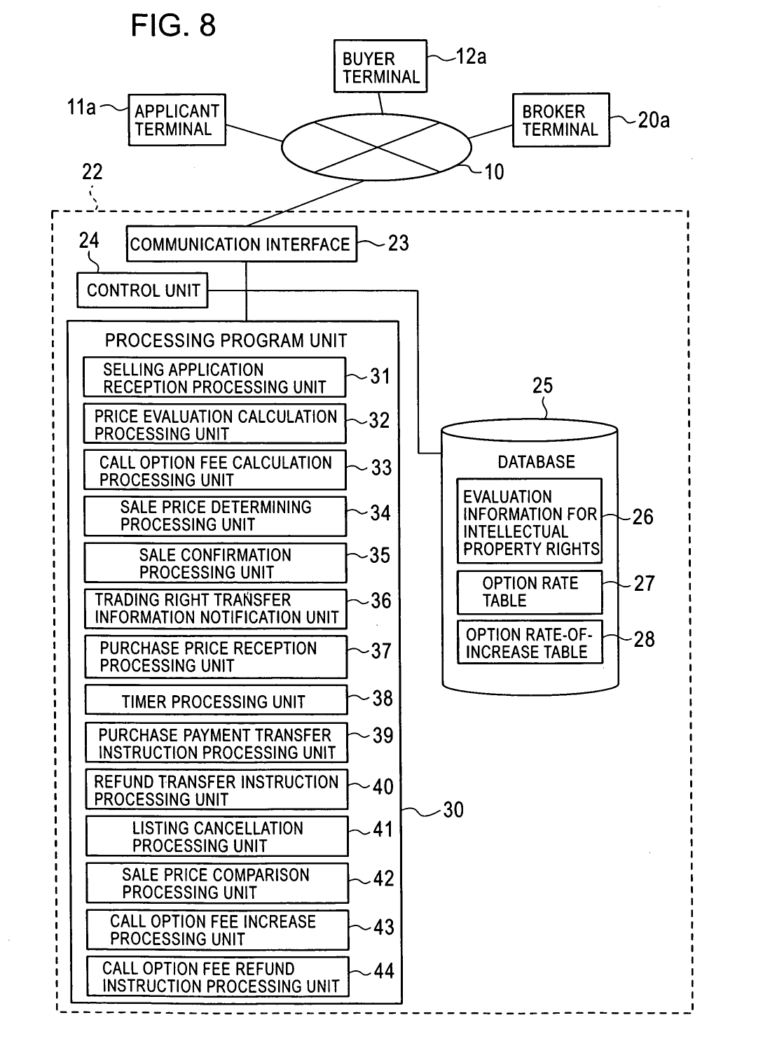

Next, description will be made regarding the configuration of the server 22 in the Web site 21 with reference to FIG. 8. FIG. 8 illustrates only a part of the configuration of the server 22 directly relevant to the present invention. In FIG. 8, 23 denotes a communication interface for connecting the server 22 to the Internet 10, a control unit for integrally controlling the entire server 22, and 25 denotes a database.

The evaluation information for intellectual property rights 26 of the database 25 is information for performing price evaluation of an intellectual property right applied for selling. As described above, in the event that the information of the intellectual property right applied for selling is not included in the database 25, necessary information is acquired from an external intellectual property right information providing organization (“Japan Patent Information Organization” and the like, in the case of patent rights), and added in the database 25.

The option rate table 27 is a table recording the option rate information used for calculating a call option fee as described above.

The option rate-of-increase table 28 is a table used for calculating this increase for increasing the call option for each predetermined period, in the event that the remaining period of the selling period is within a predetermined period.

A processing program unit 30 includes the following processing units.

A selling application reception processing unit 31 is a processing unit for receiving information of the application for selling an intellectual property right, the content of the right, the selling period thereof from the applicant terminal 11a of the applicant 11.

A price evaluation calculation processing unit 32 is a processing unit for referring to the database 25 retaining the right situation of a right to be sold and the information for evaluating the right, and determining the value evaluation price of a right to be sold.

A call option fee calculation processing unit 33 is a processing unit for referring to the option rate table 27, and calculating a call option fee based on a selling period and value evaluation price.

A sale price determining processing unit 34 is a processing unit for determining the sale price of an intellectual property right to be sold based on a value evaluation price and the call option fee.

A sale confirmation processing unit 35 is a processing unit for sending information of a value evaluation price, the call option fee, and a sale price (as necessary) to the terminal 11a of the applicant 11, and receiving “sale confirmation information” (i.e., a selling signal) to the effect that sale is approved from the terminal 11a of the applicant 11.

A trading right transfer information notification processing unit 36 is a processing unit for receiving “sale confirmation information” from the terminal 11a of the applicant 11, either listing on the Web page for brokers within the Web site that the trading right of an intellectual property right to be sold can be transferred to the broker 20, or notifying that to the terminal 20a of the broker 20 by e-mail.

A purchase price reception processing unit 37 is a processing unit for listing the sale information of an intellectual property right to be sold on a Web site, and accepting presentation of a purchase price via the terminal 12a of the buyer 12.

A timer processing unit 38 is a processing unit for monitoring a date when the sale information of an intellectual property right to be sold is listed on the Web site, and a selling period.

A purchase payment transfer instruction processing unit 39 is a processing unit for sending transfer instruction information of purchase payment as to the broker 20 to the terminal 12a of the buyer 12 in the event that there is an application for purchase from the terminal 12a of the buyer 12, and trading thereof is successful.

A refund transfer instruction processing unit 40 is a processing unit for sending transfer instruction information of refunds (value evaluation price−call option fee) as to the applicant 11 to the terminal 20a of the broker 20 in the event that there is an application for purchase from the terminal 12a of the buyer 12, trading thereof is successful, and the intellectual property right is transferred to the buyer 12 from the applicant 11.

A listing cancellation processing unit 41 is a processing unit for canceling listing an intellectual property right to be sold on the Web site in accordance with a signal from the timer processing unit 38, and also sending a “signal to the effect that trading was unsuccessful” to the terminal 20a of the broker 20 and the terminal 11a of the applicant 11 in the event that a “buying signal” is not received from the terminal 12a of the buyer 12, and also a selling period is elapsed.

A sale price comparison processing unit 42 is a processing unit for comparing a value evaluation price, a calculated price calculated from the call option fee, and a desired price of the applicant 11, and listing the content and sale price of an intellectual property right to be sold on the Web site, in the event that the desired price is equal to or less than the calculated price. Note that this processing unit 42 is provided as necessary.

A call option fee increase processing unit 43 is a processing unit for increasing the call option fee for each certain period, and sending the information regarding increase of the call option fee to the terminal 20a of the broker 20 in the event that the remaining period of a selling period reaches a certain limit period or less. Note that this processing unit 42 is provided as necessary.

A call option fee refund instruction processing unit 44 is a processing unit for sending refund instruction information of the call option fee paid to the applicant 11 to the terminal 11a of the applicant 11 in the event that an intellectual property right to be sold is sold. Note that this processing unit 42 is provided as necessary.

Note that this processing program unit 30 may be realized by dedicated hardware, or an arrangement may be made wherein this processing program unit is configured of a general-purpose information processing device such as memory and a CPU (Central Processing Unit), and the functions thereof are realized by loading a program (not shown) for realizing the functions of this processing unit to the memory, and executing this program.

Also, the server 22 in this Web site is connected with an unshown input device, an unshown display device, and the like, as peripheral equipment. Here, the input device is an input device such as a keyboard or a mouse, and the display device is a CRT (Cathode Ray Tube), a liquid crystal display device, or the like.

Heretofore, while description has been made regarding the embodiment of the present invention, an arrangement may be made wherein a program for realizing the functions of the processing program unit 30 within the server 22 in the Web site illustrated in FIG. 8 is recorded in a computer-readable recording medium, a computer system reads and executes the program recorded in this recording medium, whereby processing necessary for the processing program unit 30 within the server 22 in the Web site illustrated in FIG. 8. Note that the above-described “computer system” includes an OS (Operating System) and hardware such as peripheral equipment.

Also, a “computer-readable recording medium” means a portable medium such as a flexible disk, optical disk, memory card, or CD-ROM, or a hard disk and so forth to be built in the computer system.

Furthermore, a “computer-readable recording medium” includes a medium (transmission medium or transmitted waves) for retaining a program dynamically for a short period such as a communication line in the case of transmitting a program via a network such as the Internet or the communication line such as a telephone line, and a medium for retaining a program for a certain period such as volatile memory within the computer system serving as a server or client in that case. Also, the above-described program may be a program for realizing a part of the aforementioned functions, or further a program for realizing the aforementioned functions in combination with the program already recorded in the computer system, i.e., a so-called difference file (difference program).

Heretofore, while description has been made regard the embodiment in the intellectual property right selling/buying system according to the present invention, the present invention is not restricted by the above-described examples illustrated by way of the drawings, and it is needless to say that various modifications can be made without departing from the spirit and scope of the invention.

Examples of intellectual property rights to which the present invention can be applied include design rights, trademark rights, and copyrights as well as patent rights and utility model rights.

Also, examples of the selling/buying method to which the present invention can be applied include various methods such as the auction method and the stock trading method.

1. An intellectual property right selling/buying system comprising:
a selling application reception unit for receiving information regarding the selling application of a right to be sold, the content of a right, and a selling period, from an applicant terminal applying for sale of an intellectual property right;
a database for retaining evaluation data to be used for evaluation of said right to be sold;
a price evaluation calculation unit for referencing said database, and determining a value evaluation price of said right to be sold;
a call option fee calculation unit for calculating a call option fee based on said selling period and said value evaluation price in accordance with a certain standard;
a sale price determining unit for determining a sale price of said right to be sold based on said value evaluation price and said call option fee;
a reception unit for receiving information to the effect that a buyer terminal desiring to apply for purchase of said right to be sold applies for purchase;
a purchase payment transfer instruction unit for sending instruction information for instructing said buyer to transfer purchase payment to a broker to said buyer terminal in the event that said buyer terminal applied for purchase, and trading is successful; and
a refund transfer instruction unit for sending instruction information for instructing said broker to transfer refunds determined based on said value evaluation price and said call option fee to an applicant to said broker terminal in the event that said trading is successful.

2. An intellectual property right selling/buying system according to claim 1, further comprises an option rate database correlating said selling period, said value evaluation price, with calculation rate data of a call option fee, and recording these,
wherein said call option fee calculation unit references said option rate database, and calculates said call option fee.

3. An intellectual property right selling/buying system according to claim 1, further comprising:
a desired sale price reception unit for receiving information of desired sale price of an applicant when said selling application reception unit receives the selling application of an intellectual property right from the applicant;
a sale price comparison unit for comparing a calculated sale price calculated from said value evaluation price and said call option fee with said desired sale price; and
a listing unit for listing the content of a right to be sold, and said calculated sale price in the case wherein said desired sale price is equal to or less than said calculated sale price.

4. An intellectual property right selling/buying system according to claim 1, further comprising a call option fee increase unit for increasing said call option fee for each certain period in the event that the remaining period of said selling period reaches a predetermined limit period or less.

5. An intellectual property right selling/buying system according to claim 4, wherein said call option fee increase unit stops increase of said call option fee in the event that a buying price serving as a current sale price and said call option fee satisfy the following relation:
buying price−call option fee<value evaluation price.

6. An intellectual property right selling/buying system according to claim 4, further comprising a call option fee increase notification unit for sending the call option fee increase information to the terminal of said broker in the event that said call option fee is increased.

7. An intellectual property right selling/buying system according to claim 1, further comprising a call option fee refund instruction unit for sending information to the terminal of said applicant for instructing said applicant to refund to the broker the call option fee paid to said applicant in the event that said right to be sold is sold.

8. An intellectual property right selling/buying method comprising:
a selling application reception step for receiving information regarding the selling application of a right to be sold, the content of a right, and a selling period, from an applicant terminal applying for sale of intellectual property;
a price evaluation calculation step for referencing a property right database for retaining evaluation data to be used for evaluation of said right to be sold, and determining a value evaluation price of said right to be sold;
a call option fee calculation step for calculating a call option fee based on said selling period and said value evaluation price in accordance with a certain standard;
a sale price determining step for determining a sale price of said right to be sold based on said value evaluation price and said call option fee;
a reception step for receiving information to the effect that a buyer terminal desiring to apply for purchase of said right to be sold applies for purchase;
a purchase payment transfer instruction step for sending instruction information for instructing said buyer to transfer purchase payment to a broker to said buyer terminal in the event that said buyer terminal applied for purchase, and trading is successful; and
a refund transfer instruction step for sending instruction information for instructing said broker to transfer refunds determined based on said value evaluation price and said call option fee to an applicant to said broker terminal in the event that said trading is successful.

9. An intellectual property right selling/buying program for controlling a computer to execute intellectual property right selling/buying processing, said program comprising:
a selling application reception step for receiving information regarding the selling application of a right to be sold, the content of a right, and a selling period, from an applicant terminal applying for sale of intellectual property;
a price evaluation calculation step for referencing a property right database for retaining evaluation data to be used for evaluation of said right to be sold, and determining a value evaluation price of said right to be sold;
a call option fee calculation step for calculating a call option fee based on said selling period and said value evaluation price in accordance with a certain standard;
a sale price determining step for determining a sale price of said right to be sold based on said value evaluation price and said call option fee;
a reception step for receiving information to the effect that a buyer terminal desiring to apply for purchase of said right to be sold applies for purchase;
a purchase payment transfer instruction step for sending instruction information for instructing said buyer to transfer purchase payment to a broker to said buyer terminal in the event that said buyer terminal applied for purchase, and trading is successful; and
a refund transfer instruction step for sending instruction information for instructing said broker to transfer refunds determined based on said value evaluation price and said call option fee to an applicant to said broker terminal in the event that said trading is successful.

10. An computer-readable recording medium storing an intellectual property right selling/buying program for controlling a computer to execute intellectual property right selling/buying processing, said program comprising:
a selling application reception step for receiving information regarding the selling application of a right to be sold, the content of a right, and a selling period, from an applicant terminal applying for sale of intellectual property;
a price evaluation calculation step for referencing a property right database for retaining evaluation data to be used for evaluation of said right to be sold, and determining a value evaluation price of said right to be sold;
a call option fee calculation step for calculating a call option fee based on said selling period and said value evaluation price in accordance with a certain standard;
a sale price determining step for determining a sale price of said right to be sold based on said value evaluation price and said call option fee;
a reception step for receiving information to the effect that a buyer terminal desiring to apply for purchase of said right to be sold applies for purchase;
a purchase payment transfer instruction step for sending instruction information for instructing said buyer to transfer purchase payment to a broker to said buyer terminal in the event that said buyer terminal applied for purchase, and trading is successful; and
a refund transfer instruction step for sending instruction information for instructing said broker to transfer refunds determined based on said value evaluation price and said call option fee to an applicant to said broker terminal in the event that said trading is successful.
